(19) United States
(12) Patent Application Publication
(10) Pub. No.: US 2012/0153895 A1
(43) Pub. Date: Jun. 21, 2012

(54) System And Method For Controlling AC Line Current And Power During Vehicle Battery Charging

(75) Inventors: Allan Roy Gale, Livonia, MI (US); Paul Theodore Momcilovich, Tecumseh, MI (US); Michael W. Degner, Novi, MI (US)

(73) Assignee: FORD GLOBAL TECHNOLOGIES, LLC, Dearborn, MI (US)

(21) Appl. No.: 12/972,746

(22) Filed: Dec. 20, 2010

(51) Int. Cl. H02J 7/00

(52) U.S. Cl. 320/109

(57) ABSTRACT

An automotive vehicle power system includes a battery charger having an input and output. The battery charger receives electrical energy via the input when the input is electrically connected with an electrical power source. The battery charger also alters at least one of a voltage set point and current provided at the output such that a power associated with the energy received from the power source remains approximately equal to a power target as a voltage associated with the energy received from the power source varies.

### BACKGROUND

The National Electric Code (NEC) requires that the AC line load for a 15 A circuit not exceed 80% of rating (12 A) for continuous loads (3 hr or longer). The NEC also requires that the AC line power not exceed 1440 W.

### SUMMARY

A vehicle may include a battery charger that has an input and output and that receives electrical energy via the input when the input is electrically connected with an electrical power source. The vehicle may also include a battery electrically connected with the output.

The battery charger may control current provided to the battery via the output such that a power associated with the energy received from the power source is approximately equal to a power target.

### BRIEF DESCRIPTION OF THE DRAWINGS

FIG. 1 is a block diagram of an automotive vehicle electrically connected with an electrical grid.

FIG. 2 is a flow chart depicting an algorithm for controlling AC line current and power while charging the batteries of FIG. 1.

FIG. 3 is a flow chart depicting another algorithm for controlling AC line current and power while charging the batteries of FIG. 1.

### DETAILED DESCRIPTION

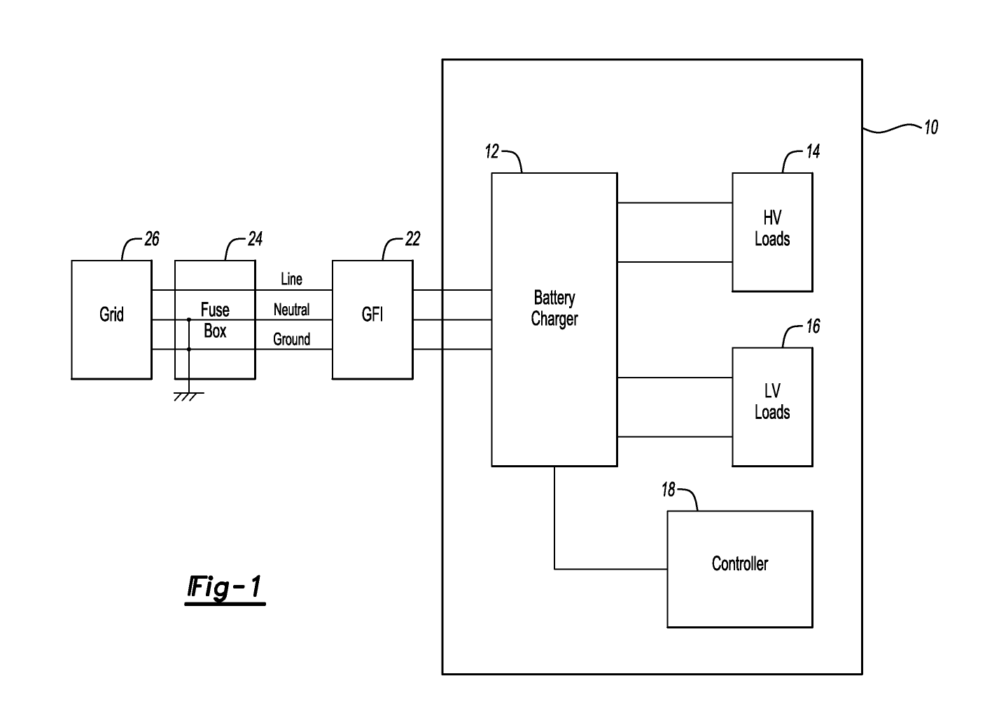

Referring to FIG. 1, a vehicle 10 (e.g., battery electric vehicle, plug-in hybrid electric vehicle, etc.) includes a battery charger 12, high voltage loads 14 (e.g., a traction battery, electric machine, etc.) and low voltage loads 16 (e.g., a +12V battery, logic circuitry, etc.) The battery charger 12 is electrically connected with the high voltage loads 14 and low voltage loads 16. The vehicle 10 also includes a controller 18. The battery charger 12 is in communication with/under the control of the controller 18. Other arrangements including a different number of loads, chargers, controllers, etc. are also possible.

The battery charger 12 is configured to receive electrical power from an electrical grid 26 (or other electrical power source). The vehicle 10, for example, may be plugged in to a wall outlet such that the battery charger 12 is electrically connected with the electrical grid 26 via a ground fault interrupter (GFI) 22 (or similar device) and fuse box 24. Line and neutral wires (the AC line) and a ground wire are shown, in this example, electrically connecting the battery charger 12 and grid 26. The ground wire is electrically connected with the neutral wire and earth ground at the fuse box 24. Other electrical configurations, such as a 240 V arrangement with L1, L2 and ground wires, are of course also possible.

The battery charger 12 may determine (e.g., measure) the voltage and current of the AC line as well as the voltage and current output to the loads 14, 16. The battery charger 12, in the embodiment of FIG. 1, can control the high voltage output current (the current output to the high voltage loads 14) and the low voltage output voltage set point (the set point of the voltage output to the low voltage loads 16). The battery charger 12, however, may be configured to control any combination of the high voltage and/or low voltage output currents and/or voltage set points.

The above mentioned low voltage control may allow the low voltage system to supply smooth regulated output low voltage for control electronics by supplying all required current to maintain the set point voltage up to the limit of the converter design. While the high voltage output of the battery charger 12, in the embodiment of FIG. 1, has both a smooth voltage and current (power output can thus easily be maintained), the low voltage power output can fluctuate depending on loads turning on and off in the vehicle 10.

The general equation relating the input power, P_{acline}, to the charger output power is

$${P}_{acline} = \frac{{V}_{HV} * {I}_{HV}}{{η}_{HV}} + \frac{{V}_{LV} * {I}_{LV}}{{η}_{LV}} \qquad ( 1 )$$

where V_{HV} and I_{HV} are the charger measured high voltage output voltage and current respectively, V_{LV} and I_{LV} are the charger measured low voltage output voltage and current respectively, and η_{HV} and η_{LV} are the conversion efficiencies between the AC line and the high voltage and low voltage outputs respectively. (The efficiency of conversion varies with power output, input voltage, converter temperature, internal charger component power draw and other factors.)

According to (1), one or both of the battery charger outputs (high voltage and low voltage) can be controlled to regulate the power and current on the AC line. In one example, the low voltage output is left at the demanded level and the high voltage current is reduced to control the AC line power. Other scenarios are also possible.

(1) can be rewritten as

$$\begin{matrix}{P}_{acline} = \frac{{V}_{HV} * {I}_{HV} + {V}_{LV} * {I}_{LV}}{{η}_{charger}} where & ( 2 ) \\ {P}_{acline} = {V}_{ac} * {I}_{ac} and & ( 3 ) \\ {η}_{charger} = \frac{{V}_{HV} * {I}_{HV} + {V}_{LV} * {I}_{LV}}{{P}_{acline}} & ( 4 )\end{matrix}$$

and a new value of I_{VH} can be calculated from (2), (3) and (4) as follows

$${I}_{{HV}_{command}} ≅ \frac{{P}_{acline} * {η}_{charger} - {V}_{LV} * {I}_{LV}}{{V}_{HV}} \qquad ( 5 )$$

where I_{HVcommand} is the new charge rate command to the battery charger 12 for charging the high voltage battery 14.

The net efficiency of the battery charger 12 may first be determined from (4). With this, (5) may be used to calculate an updated high voltage charge current that would maintain the load power below the AC line limit (e.g., 1440 W). By substituting (3) into (5) and setting I_{ac} equal to the AC line current limit (e.g., 12 A), an updated high voltage charge current that would maintain the AC line current below its limit may also be calculated. Because the efficiencies in (1) vary with AC line conditions, (5) may result in a slight error that will be reduced each time the algorithm is performed.

The above process may be repeated on a continual basis to regulate the input power or current limit, whichever is lower, as needed. An example of excessive power and excessive current draw can be shown by considering (3). Assume that the battery charger 12 is operating on a 15 A circuit. As mentioned above, the NEC limits continuous current to 12 A. Also assume that the battery charger 12 has an internal limit of 1440 W while the actual AC line voltage is 115V_{ac}. From (3), the maximum allowed P_{acline} would be 1380 W and the algorithm would limit I_{ac} to 12 A according to (5). Now consider what happens when V_{ac} increases to 130V_{ac}. From (3), I_{ac} must be reduced to 11 A to limit the input power to 1440 W. (5) can be used to calculate the new high voltage current command.

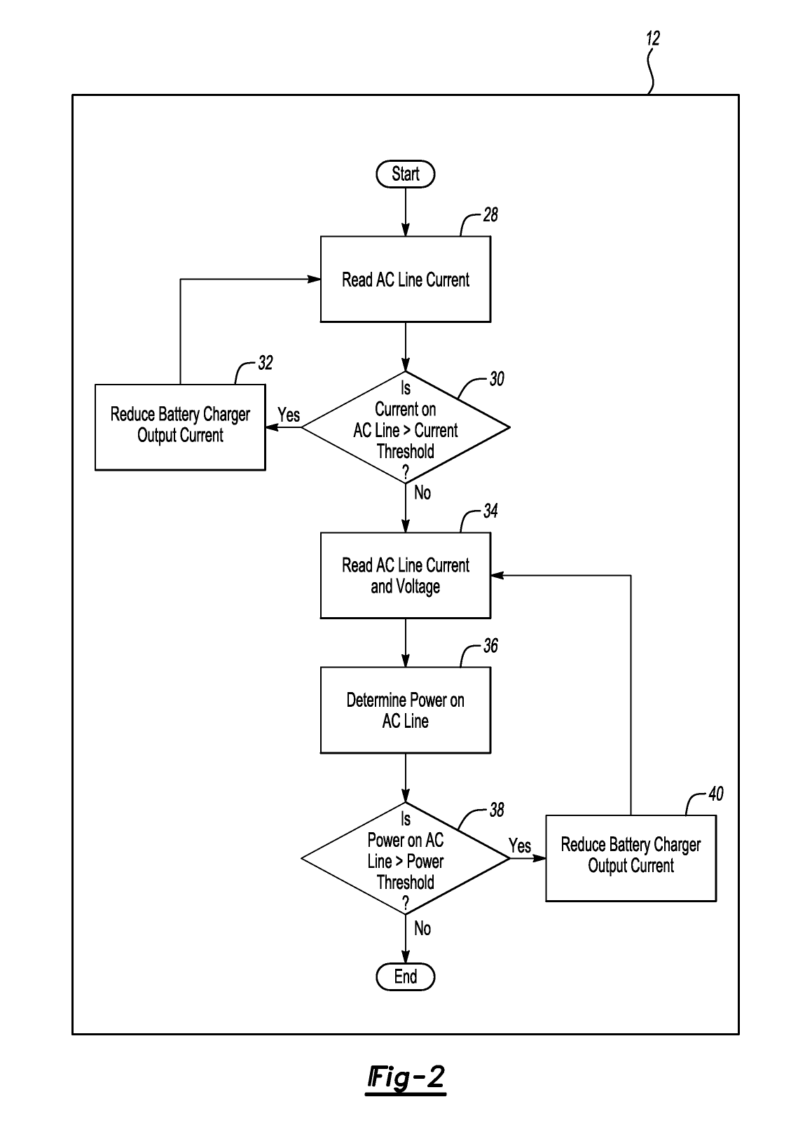

Referring to FIG. 2, the AC line current may be read at operation 28. The battery charger 12, for example, may read (determine, measure, etc.) the AC line current in any suitable/known fashion. At operation 30, it is determined whether the AC line current is greater than a current threshold. The battery charger 12, for example, may determine whether the AC line current exceeds 12 A. If yes, the battery charger output current is reduced at operation 32. For example, the battery charger 12 may reduce the high voltage (and/or low voltage) output current by 0.5 A. The algorithm then returns to operation 28.

Returning to operation 30, if no, the AC line current and voltage is read at operation 34. The battery charger 12, for example, may read the AC line current and voltage in any suitable/known fashion. At operation 36, the AC line power is determined. The battery charger 12, for example, may determine the AC line power according to (3). At operation 38, it is determined whether the AC line power is greater than a power threshold. For example, the battery charger 12 may determine whether the AC line power is greater than 1440 W. If no, the algorithm ends. If yes, the battery charger output current is reduced at operation 40. The battery charger 12, for example, may reduce the high voltage (and/or low voltage) output current by 1 A. The algorithm then returns to operation 34.

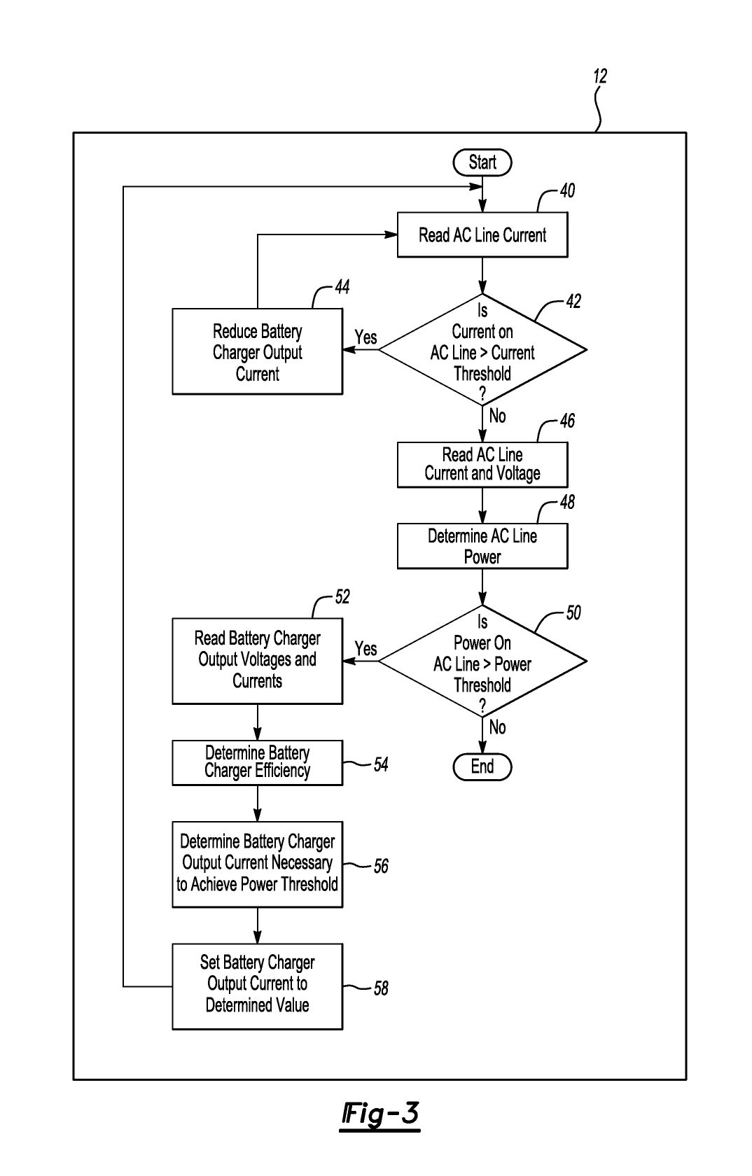

Referring to FIG. 3, the AC line current may be read at operation 40. The battery charger 12, for example, may read the AC line current in any suitable/known fashion. At operation 42, it is determined whether the AC line current is greater than a current threshold. The battery charger 12, for example, may determine whether the AC line current exceeds 12 A. If yes, the battery charger output current is reduced at operation 44. For example, the battery charger 12 may reduce the high voltage (and/or low voltage) output current by 0.5 A. The algorithm then returns to operation 40.

Returning to operation 42, if no, the AC line current and voltage is read at operation 46. The battery charger 12, for example, may read the AC line current and voltage in any suitable/known fashion. At operation 48, the AC line power is determined. The battery charger 12, for example, may determine the AC line power according to (3). At operation 50, it is determined whether the AC line power is greater than a power threshold. For example, the battery charger 12 may determine whether the AC line power is greater than 1440 W. If no, the algorithm ends. If yes, the battery charger output voltages and currents are read at operation 52. The battery charger 12, for example, may read the output voltages and currents in any suitable/known fashion. At operation 54, the battery charger efficiency is determined. The battery charger 12, for example, may determine the battery charger efficiency according to (4). At operation 56, the battery charger output current necessary to achieve the power threshold is determined. The battery charger 12, for example, may determine the high voltage output current according to (5) assuming a power threshold of 1440 W. At operation 58, the battery charger output current is set to the value determined at operation 56. The algorithm then returns to operation 46. (Output voltages/set points may similarly be controlled to control the AC line current and power.)

In alternative embodiments, the desired charger output current required to keep the AC line current at or below its limit may be determined directly by employing operations similar to operations 52, 54, 56. For example, after determining the AC line current and voltage and the battery charger output voltages and currents, the battery charger efficiency may be determined according to (4). The battery charger output current necessary to achieve the AC line current limit may then be determined according to (3) and (5) assuming an I_{ac} of, in this example, 12 A.

The algorithms disclosed herein may be deliverable to/performed by a processing device, such as the battery charger 12 or controller 18, which may include any existing electronic control unit or dedicated electronic control unit, in many forms including, but not limited to, information permanently stored on non-writable storage media such as ROM devices and information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed:

1. An automotive vehicle power system comprising:
a battery charger having an input and output and configured to (i) receive electrical energy via the input when the input is electrically connected with an electrical power source and (ii) alter at least one of a voltage set point and current provided at the output such that a power associated with the energy received from the power source remains approximately equal to a power target as a voltage associated with the energy received from the power source varies.

2. The system of claim 1 wherein the battery charger is further configured to determine the power associated with the energy received from the power source, to compare the power with the power target, and to reduce the at least one of the voltage set point and current provided at the output if the power is greater than the power target.

3. The system of claim 1 wherein the battery charger is further configured to alter the at least one of the voltage set point and current provided at the output such that a current associated with the energy received from the power source remains approximately equal to a current target.

4. The system of claim 3 wherein the battery charger is further configured to determine the current associated with the energy received from the power source, to compare the current with the current target, and to reduce the at least one of the voltage set point and current provided at the output if the current is greater than the current target.

5. The system of claim 1 further comprising a traction battery electrically connected with the output.

6. A vehicle comprising:
a battery charger (i) having an input and output and (ii) configured to receive electrical energy via the input when the input is electrically connected with an electrical power source; and
a battery electrically connected with the output, wherein the battery charger is further configured to control current provided to the battery via the output such that a power associated with the energy received from the power source is approximately equal to a power target.

7. The vehicle of claim 6 wherein the battery charger is further configured to control a voltage set point at the output such that the power associated with the energy received from the power source is approximately equal to the power target.

8. The vehicle of claim 6 wherein the battery charger is further configured to control the current provided to the battery via the output such that a current associated with the energy received from the power source is less than a current threshold.

9. The vehicle of claim 8 wherein the battery charger is further configured to determine the current associated with the energy received from the power source, to compare the current with the current threshold, and to reduce the current provided to the battery via the output if the current is greater than the current threshold.

10. The vehicle of claim 6 wherein the battery charger is further configured to control a voltage set point at the output such that a current associated with the energy received from the power source is less than a current threshold.

11. The vehicle of claim 6 wherein the battery charger is further configured to determine the power associated with the energy received from the power source, to compare the power with the power target, and to reduce the current provided to the battery via the output if the power is greater than the power target.

12. The vehicle of claim 6 wherein the battery is a traction battery.

13. A method for controlling a power on an AC line electrically connected with a vehicle battery charger comprising:
determining whether the power on the AC line exceeds a target; and
altering at least one of a current and a voltage set point output by the vehicle battery charger such that the power on the AC line is approximately equal to the target if the power on the AC line exceeds the target.

14. The method of claim 13 further comprising determining whether a current on the AC line exceeds a threshold and altering the at least one of the current and voltage set point output by the vehicle battery charger such that the current on the AC line is approximately equal to the threshold if the current on the AC line exceeds the threshold.

15. The method of claim 14 further comprising determining the current on the AC line and comparing the current on the AC line with the threshold.

16. The method of claim 15 wherein altering the at least one of the current and voltage set point output by the vehicle battery charger such that the current on the AC line is approximately equal to the threshold if the current on the AC line exceeds the threshold includes reducing the at least one of the current and voltage set point output by the vehicle battery charger.

17. The method of claim 13 further comprising determining the power on the AC line and comparing the power on the AC line with the target.

18. The method of claim 17 wherein altering at least one of a current and voltage set point output by the vehicle battery charger such that the power on the AC line is approximately equal to the target if the power on the AC line exceeds the target includes reducing the at least one of the current and voltage set point output by the vehicle battery charger.
